(19) United States
(12) Patent Application Publication
(10) Pub. No.: US 2023/0237445 A1
(43) Pub. Date: Jul. 27, 2023

(54) PREVENTATIVE MAINTENANCE AND USEFUL LIFE ANALYSIS TOOL

(71) Applicant: Cummins Inc., Columbus, IN (US)

(72) Inventors: Thomas L. McKinley, Columbus, IN (US); Zigmund W. Meluskey, Greenwood, IN (US); Meghana Somwanshi, Pune (IN); Devawrat S. Bhave, Maharashtra (IN); Sandeep Verma, Pune (IN)

(73) Assignee: Cummins Inc., Columbus, IN (US)

(21) Appl. No.: 18/128,151

(22) Filed: Mar. 29, 2023

Related U.S. Application Data
(63) Continuation of application No. PCT/US21/52686, filed on Sep. 29, 2021.

(30) Foreign Application Priority Data
Oct. 1, 2020 (IN) 202041042848

(51) Int. Cl. G06Q 10/20; G06Q 10/1093; G07C 5/06

(52) U.S. Cl. CPC G06Q 10/20; G06Q 10/1095; G07C 5/06

(57) ABSTRACT

Systems and apparatuses include one or more processing circuits comprising one or more memory devices coupled to one or more processors, the one or more memory devices configured to store instructions thereon that, when executed by the one or more processors, cause the one or more processors to: receive vehicle information including operating conditions and historical vehicle information, develop a vehicle model using a machine learning engine that receives the vehicle information, determine a fleet failure probability based on the vehicle model and fleet information including fleet usage and fleet vehicle types, and determine a predictive maintenance schedule based on the fleet failure probability.

### CROSS REFERENCE TO RELATED APPLICATIONS

This application is a continuation of International Patent Application No. PCT/US2021/052686, filed on Sep. 29, 2021, which claims priority to and the benefit of Indian Patent Application No. 202041042848, filed on Oct. 1, 2020, both of which are incorporated herein by reference in their entireties.

### TECHNICAL FIELD

The present disclosure relates to vehicle fleet management. More particularly, the present disclosure relates to systems and methods for improving maintenance of a fleet of vehicles.

### BACKGROUND

Typically, fleets of vehicles are repaired using a reactionary maintenance scheme. When a component or sensor fails, the vehicle is taken offline, and brought in for service to repair the component or sensor. In a bussing fleet, as an example, this reactive maintenance leads to dissatisfied riders who must transfer busses and delay their arrival at their ultimate destination. Downtime of fleet vehicles is undesirable.

### SUMMARY

One embodiment relates to an apparatus that includes one or more processing circuits comprising one or more memory devices coupled to one or more processors, the one or more memory devices configured to store instructions thereon that, when executed by the one or more processors, cause the one or more processors to: receive vehicle information including operating conditions and historical vehicle information, develop a vehicle model using a machine learning engine that receives the vehicle information, determine a fleet failure probability based on the vehicle model and fleet information including fleet usage and fleet vehicle types, and determine a predictive maintenance schedule based on the fleet failure probability.

Another embodiment relates to a system that includes one or more processing circuits comprising one or more memory devices coupled to one or more processors, the one or more memory devices configured to store instructions thereon that, when executed by the one or more processors, cause the one or more processors to: receive vehicle information and fleet information, develop an analytics model based on the received vehicle information and fleet information, determine a predicted component life using the analytics model, determine a predictive maintenance schedule based on the predicted component life, and generate a report indicating maintenance scheduled within the predictive maintenance interval; and an application communicably coupled to the one or more processing circuits and structured to provide the predictive maintenance interval and display the report.

Another embodiment relates to a system that includes one or more processing circuits comprising one or more memory devices coupled to one or more processors, the one or more memory devices configured to store instructions thereon that, when executed by the one or more processors, cause the one or more processors to: receive vehicle information and fleet information, develop an analytics model based on the received vehicle information and fleet information, determine a total life prediction using the analytics model and based on a current life of the target component and a remaining useful life of a target component, receive a threshold failure rate from the application and determine when the threshold failure rate is predicted to be achieved based on the total life prediction, determine a predictive maintenance schedule based on the total life prediction, and generate a report indicating maintenance scheduled within the predictive maintenance interval; and an application communicably coupled to the one or more processing circuits and structured to provide the predictive maintenance interval and display the report.

Still another embodiment relates to a method. The method includes: receiving vehicle information and fleet information; developing an analytics model based on the received vehicle information and fleet information; determining a total life prediction using the analytics model and based on a current life of a target component and a remaining useful life of the target component; receiving a threshold failure rate; determining when the threshold failure rate is predicted to be achieved based on the total life prediction; determining a predictive maintenance interval based on the total life prediction; generating a report indicating maintenance scheduled within the predictive maintenance interval and indicating when the threshold failure rate is predicted to be achieved based on the total life prediction; and displaying the report.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Additionally, one or more features of an aspect of the invention may be combined with one or more features of a different aspect of the invention.

### BRIEF DESCRIPTION OF THE FIGURES

FIG. 1 is a schematic diagram of a system for determining a preventative maintenance schedule according to some embodiments.

FIG. 2 is a schematic diagram of a controller of the system of FIG. 1 according to some embodiments.

FIG. 3 is a flow diagram showing a failure mileage determination using the system of FIG. 1, according to some embodiments.

FIG. 4 is a chart showing a predicted failure rate curve determined by the system of FIG. 1, according to some embodiments.

FIG. 5 is a depiction of an application for interacting with the system of FIG. 1, according to some embodiments.

FIG. 6 is a depiction of charts produced within the application of FIG. 5, according to some embodiments.

FIG. 7 is a chart showing parameter convergence as used by the system of FIG. 1, according to some embodiments.

FIG. 8 is a chart showing parameter selection as used by the system of FIG. 1, according to some embodiments.

FIG. 9 is a chart showing a predicted failure rate curve determined by the system of FIG. 1 for an engine out NOx sensor, according to some embodiments.

FIG. 10 is a chart showing a predicted failure rate curve determined by the system of FIG. 1 for a tailpipe NOx sensor, according to some embodiments.

### DETAILED DESCRIPTION

Following below are more detailed descriptions of various concepts related to, and implementations of, methods, apparatuses, and systems for determining a remaining useful life and an advantageous maintenance schedule for vehicle components. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the Figures generally, the various embodiments disclosed herein relate to systems, apparatuses, and methods for determining an advantageous maintenance schedule for a fleet of vehicles that takes into account the engines and vehicle components of individual vehicles within the fleet. Each vehicle/engine/component is monitored over time to determine vehicle information (e.g., ambient temperature during use, mileage, average speed, fuel consumption over time, model year, warranty history, maintenance history, fault codes, etc.). The vehicle information is received by an analytics model (e.g., a machine learning engine, a predictive model, an algorithm etc.) that generates a remaining useful life (RUL) of a target component (e.g., a HEGO sensor) and generates a model of predicted maintenance over the RUL of the target component. The system receives vehicle information from all vehicles associated with the system. In some embodiments, the vehicle information includes warranty data from the original equipment manufacturer and/or its original equipment suppliers, vehicle information related to a make or model of a vehicle component or subsystem, or vehicle information and data associated with the system in any other way. The availability of a large data set processed by the analytics model allows the system to accurately or substantially accurately predict maintenance requirements and generate a maintenance schedule based on real time or substantially real time information that significantly reduces the incidence of failures (e.g., on the road or otherwise in use). A reduction of failures on the road directly addresses a current need in the vehicle fleet industry where downtime of vehicles can lead to critical logistical breakdowns. It should be understood that the present disclosure may also be applicable with stationary equipment (e.g., gensets) and/or non-primary road equipment (e.g., front end loaders).

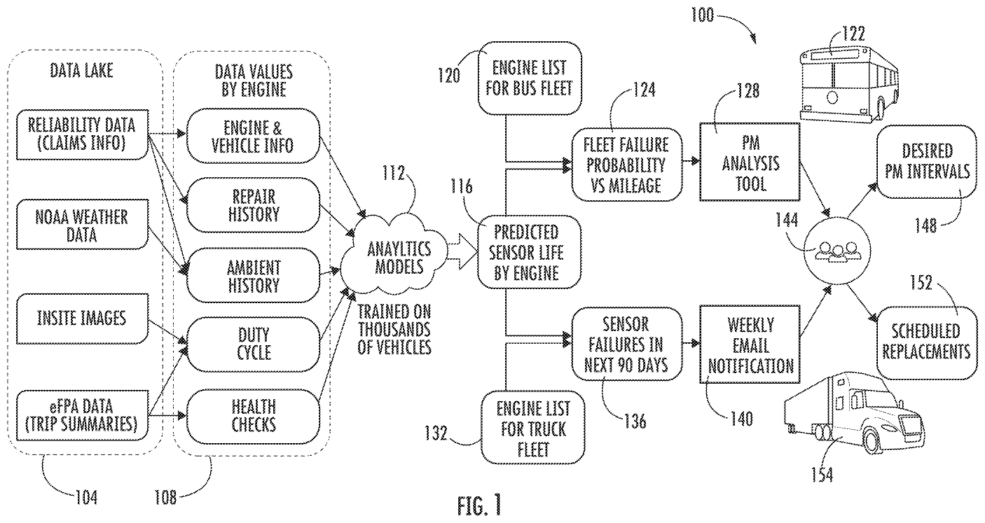

Referring now to FIG. 1, a system for determining a predictive maintenance schedule 100 is shown according to an example embodiment. The system 100 is structured to receive information from a data lake 104, merge the data lake information with a vehicle information database 108, analyze the merged data with an analytics model 112, and generate a predicted component life 116.

The data lake 104 is structured to aggregate or query information from different information sources. The data lake 104 may be structured as one or more databases storing information. Information included in the data lake 104 can include: reliability information in the form of warranty claims, manufacturer information, or other repair claim history; NOAA or other historical weather data indicating temperature, humidity and other weather or ambient condition factors that can affect component functionality and lifespan; INSITE™ diagnostics output provided by Cummins Inc. or a similar diagnostics output from an engine system or other vehicle system; and an eFPA data including trip summaries, routing information, and traffic information. The vehicle information 108 can be specific to the vehicle, the engine, or individual components, and in some embodiments includes: engine and vehicle info such as serial number, model year, date put into service, OEM, bus length, truck usage, etc.; repair history including prior repairs, past fault codes, and replaced parts; ambient history including ambient temperature, ambient pressure, and relative humidity; duty cycle including sample rate or duty cycle, usage rate, engine hours, and odometer readings; and health checks including diagnostic checks for sensor health, pressure differential checks for a turbo wastegate valve, etc. The data lake 104 and the vehicle information 108 combine to provide the information utilized by the analytics model 112 in the requisite format and order.

The system 100 also uses bus fleet information regarding buses 122 associated with a bus fleet 120 (e.g., engine types, chassis models, etc.), and truck fleet information regarding trucks 134 associated with a truck fleet 132. In some examples, the user of the system 100 manages only a bus fleet 120 or a truck fleet 132 and not both and therefore only receives either the bus fleet information or the truck fleet information.

Utilizing the bus fleet information and the predicted component life 116, the system 100 generates a fleet failure probability 124 that indicates the likelihood of a component failure over time (e.g., calendar days, vehicle/engine hours, mileage, etc.). The predicted component life is then provided to a predictive maintenance (PM) analytics tool 128. In some embodiments, the truck fleet information is similarly processed to generate a fleet failure probability 124 of truck components that is fed into the PM analytics tool 128.

The truck fleet information and the predicted component life 116 are used by the system 100 to determine predicted component failures within a future time period 136 (e.g., the next 90 days). The predicted component failures 136 are then assembled into a report 140 that can be provided to users or maintenance personnel (e.g., via email). Again, the predicted component failures 136 can also be generated using a similar process for the bus fleet 120, or both the bus fleet 120 and the truck fleet 132.

A customer service application 144 receives information from the system 100 including output of the PM analysis tool 128 and the predicted component failure report 140 and generates a PM interval 148 and a replacement schedule 152 that reduce fleet downtime and the number of post failure repair events. In some embodiments, the customer service application 144 is provided on a user device (e.g., a smartphone, tablet, a HMI, a kiosk, a wall panel, etc.) and a user is able to interact with the system 100 to affect inputs, run queries, and affect the operation of the analytics models 112, the pm analysis tool 128, and the reports 140, to provide customized solutions that improve fleet functionality. For example, the customer service application 144 may be hard coded into or a web-based application that is executable on the user device to provide one or more graphical user interfaces that shows the reports described herein, enables the queries to be inputted, and otherwise enables a user (e.g., fleet manager, etc.) to interact and utilize the system 100.

In this regard, a controller or control system may be disposed remote from the vehicles or equipment. The controller may perform the operations and functions described herein to predict the remaining useful life of the component(s).

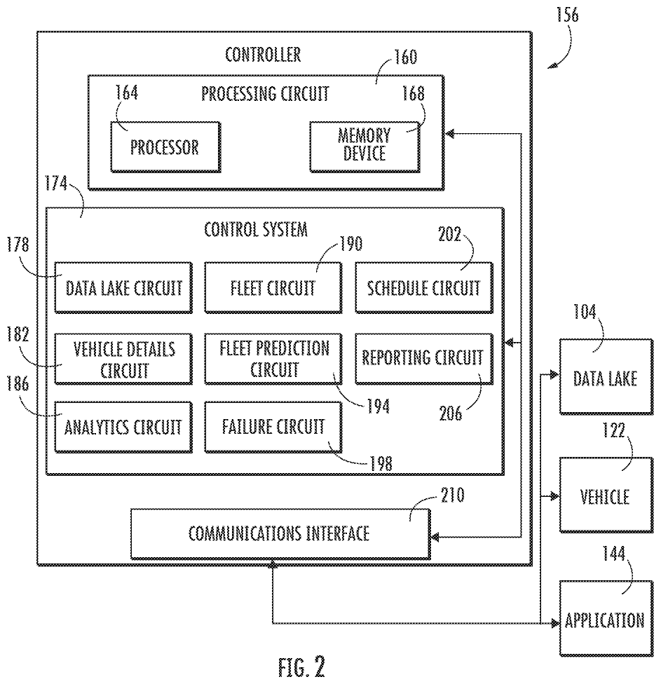

Referring now to FIG. 2, a schematic diagram of such a controller of the system 100 of FIG. 1 is shown according to an example embodiment. As shown in FIG. 2, the controller 156 includes a processing circuit 160 having a processor 164 and a memory device 168, a control system 174 having a data lake circuit 178, a vehicle details circuit 182, an analytics circuit 186, a fleet circuit 190, a fleet prediction circuit 194, a failure circuit 198, a schedule circuit 202, and a reporting circuit 206 and a communications interface 210. The controller 156 is structured to collect certain data regarding the usage of the fleet vehicles and historical maintenance requirements of the fleet vehicles and generate predictions for PM schedules and the advantages of different schedules.

In one configuration, the data lake circuit 178, the vehicle details circuit 182, the analytics circuit 186, the fleet circuit 190, the fleet prediction circuit 194, the failure circuit 198, the schedule circuit 202, and the reporting circuit 206 are embodied as machine or computer-readable media storing instructions that is executable by a processor, such as processor 164. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the data lake circuit 178, the vehicle details circuit 182, the analytics circuit 186, the fleet circuit 190, the fleet prediction circuit 194, the failure circuit 198, the schedule circuit 202, and the reporting circuit 206 are embodied as hardware units, such as electronic control units. As such, the data lake circuit 178, the vehicle details circuit 182, the analytics circuit 186, the fleet circuit 190, the fleet prediction circuit 194, the failure circuit 198, the schedule circuit 202, and the reporting circuit 206 may be embodied as one or more circuitry components including, but not limited to, processing circuitry, network interfaces, peripheral devices, input devices, output devices, sensors, etc. In some embodiments, the data lake circuit 178, the vehicle details circuit 182, the analytics circuit 186, the fleet circuit 190, the fleet prediction circuit 194, the failure circuit 198, the schedule circuit 202, and the reporting circuit 206 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the data lake circuit 178, the vehicle details circuit 182, the analytics circuit 186, the fleet circuit 190, the fleet prediction circuit 194, the failure circuit 198, the schedule circuit 202, and the reporting circuit 206 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The data lake circuit 178, the vehicle details circuit 182, the analytics circuit 186, the fleet circuit 190, the fleet prediction circuit 194, the failure circuit 198, the schedule circuit 202, and the reporting circuit 206 may also include programmable hardware devices such as field programmable gate arrays, programmable array logic, programmable logic devices or the like. The data lake circuit 178, the vehicle details circuit 182, the analytics circuit 186, the fleet circuit 190, the fleet prediction circuit 194, the failure circuit 198, the schedule circuit 202, and the reporting circuit 206 may include one or more memory devices for storing instructions that are executable by the processor(s) of the data lake circuit 178, the vehicle details circuit 182, the analytics circuit 186, the fleet circuit 190, the fleet prediction circuit 194, the failure circuit 198, the schedule circuit 202, and the reporting circuit 206. The one or more memory devices and processor(s) may have the same definition as provided below with respect to the memory device 168 and processor 164. In some hardware unit configurations, the data lake circuit 178, the vehicle details circuit 182, the analytics circuit 186, the fleet circuit 190, the fleet prediction circuit 194, the failure circuit 198, the schedule circuit 202, and the reporting circuit 206 may be geographically dispersed throughout separate locations in the vehicle. Alternatively and as shown, the data lake circuit 178, the vehicle details circuit 182, the analytics circuit 186, the fleet circuit 190, the fleet prediction circuit 194, the failure circuit 198, the schedule circuit 202, and the reporting circuit 206 may be embodied in or within a single unit/housing, which is shown as the controller 156.

In the example shown, the controller 156 includes the processing circuit 160 having the processor 164 and the memory device 168. The processing circuit 160 may be structured or configured to execute or implement the instructions, commands, and/or control processes described herein with respect to data lake circuit 178, the vehicle details circuit 182, the analytics circuit 186, the fleet circuit 190, the fleet prediction circuit 194, the failure circuit 198, the schedule circuit 202, and the reporting circuit 206. The depicted configuration represents the data lake circuit 178, the vehicle details circuit 182, the analytics circuit 186, the fleet circuit 190, the fleet prediction circuit 194, the failure circuit 198, the schedule circuit 202, and the reporting circuit 206 as machine or computer-readable media. However, as mentioned above, this illustration is not meant to be limiting as the present disclosure contemplates other embodiments where the data lake circuit 178, the vehicle details circuit 182, the analytics circuit 186, the fleet circuit 190, the fleet prediction circuit 194, the failure circuit 198, the schedule circuit 202, and the reporting circuit 206, or at least one circuit of the data lake circuit 178, the vehicle details circuit 182, the analytics circuit 186, the fleet circuit 190, the fleet prediction circuit 194, the failure circuit 198, the schedule circuit 202, and the reporting circuit 206, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 164) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Additionally, one or more processors may be distributed and function as a cloud for performing operations described herein. A processor may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., data lake circuit 178, the vehicle details circuit 182, the analytics circuit 186, the fleet circuit 190, the fleet prediction circuit 194, the failure circuit 198, the schedule circuit 202, and the reporting circuit 206 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 168 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 168 may be communicably connected to the processor 164 to provide computer code or instructions to the processor 164 for executing at least some of the processes described herein. Moreover, the memory device 168 may be or include tangible, non-transient volatile memory or non-volatile memory. Accordingly, the memory device 168 may include database components, object code components, script components, or any other type of information structure for supporting the various activities and information structures described herein.

The data lake circuit 178 is structured to receive information from the data lake 104 via the communications interface 210. In some embodiments, the data lake circuit 178 is structured to query the data lake 104 for specific information on a predetermined update schedule (e.g., once a week, once a month, etc.). The data lake circuit can also be structured to format the information received from the data lake 104 for use by the other circuits of the control system 174.

The vehicle details circuit 182 is structured to receive information from the vehicle information database 108 and from the data lake circuit 178. The vehicle details circuit 182 packages information relevant to the specific components of the engine that are in use. This information set can easily include thousands of vehicles or components information and therefore provides a robust data set for use by the system 100.

The analytics circuit 186 receives the information from the data lake circuit 178 and the vehicle details circuit 182 and generates a model that can be used to predict future operation and failure of vehicles and vehicle components. In some embodiments, the analytics circuit 186 includes a machine learning engine that learns the operational parameters of the vehicles or vehicle components in view of the operating conditions and generates a virtual vehicle based on inputs of the user. For example, a user may enter a make and model of a vehicle, an engine type, a mileage, an average speed, weather or geographic inputs, etc. and the analytics circuit 186 generates the virtual vehicle that can then be used in predictions by the controller 156 and the system 100.

The fleet circuit 190 is structured to receive information about a target fleet of vehicles. For example, how many of what type of vehicles are in the fleet, what engines are installed, what mileage and other factors of each vehicle or component. The fleet circuit 190 identifies details of the fleet for use by the controller 156 and the system 100.

The fleet prediction circuit 194 is structured to determine or predict sensor or component lifespans or remaining useful life (RUL) for the fleet of vehicles. In some embodiments, the fleet prediction circuit 194 uses a survival model to generate the RUL.

For example, a parametric Weibull model from the survival model family of RUL calculations can be used. In one example and as described herein, the sensor is a NOx sensor (e.g., for an aftertreatment system of a vehicle). In turn, the fleet prediction circuit 194 calculates the RUL based on distribution of NOx sensor failure time. As the underlying distribution of time to fail is based on Weibull, the Weibull Accelerated failure model represented as below is used:

$$S ( t ; x , y ) = exp ( - {( \frac{t}{λ ( x )} )}^{ρ ( y )} ) ,$$

where scale parameter λ and shape parameter ρ are functions of engine parameters as

λ(x)=exp(β₀+β₁x₁+ . . . +βₙxₙ)

ρ(y)=exp(α₀+α₁y₁+ . . . +αₘyₘ).

, and the cumulative hazard rate is

$$H ( t ; x , y ) = {( \frac{t}{λ ( x )} )}^{ρ ( y )}$$

The survival function provides the entire distribution of survival probability of the target engine, the sensor, or component. A selected percentile of the resulting distribution of time (e.g., mileage, hours of operation, etc.) is used as an estimate of RUL. For example, the 50th percentile can be selected as median of the distribution and results in an estimated RUL of 85 k miles. The resulting total life prediction for the non-failed sensor of this example is

Total Life=Current life (t)+RUL.

The fleet prediction circuit 194 can generate a total predicted remaining life for any component (e.g., the NOx sensor discussed above). The failure circuit 198 receives the total predicted remaining life, and determines a predicted failure mileage with an associated percentage of likelihood. For example, at 85 k miles (or another threshold) the failure probability of the NOx sensor may be 40% taking into account the model generated by the analytics circuit 186. The failure circuit 198 may receive a threshold failure rate (e.g., 50%, 75%, etc.) and query the fleet prediction circuit 194 to determine when the failure rate is predicted to be achieved. The failure circuit 198 also recognizes actual failures within the vehicles of the fleet.

The schedule circuit 202 receives inputs from the failure circuit 198, the fleet prediction circuit 194, the fleet circuit 190, and the analytics circuit 186 and generates a predictive maintenance (PM) schedule for the fleet that reduces the predicted failure rate to a selected threshold (e.g., 50%) and generates a schedule or a recommendation for maintenance of components and sensors before failure. In other words, the PM schedule will indicate maintenance is required before a component has failed. The schedule circuit 202 also adds reactive maintenance into the schedule for required repairs for failed components.

The reporting circuit 206 generates a report of the PM schedule and the reactive maintenance schedule. In some embodiments, the reporting circuit 206 generates a report of all predicted failures within a time window. For example, the report may include all sensors that are predicted to cross the failure threshold (e.g., 50% likelihood of failure) within the next 90 days. The

The control system 174 is structured to communicate and interact with the application 144 to allow the user to interact with the system 100 and determine PM schedules, set failure rate thresholds and query other information from the system 100.

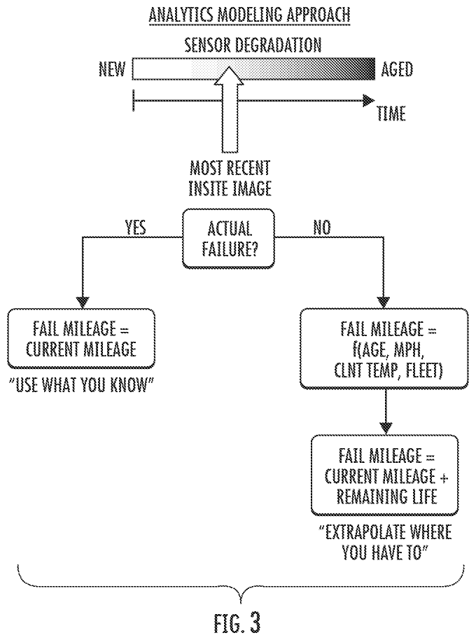

As shown in FIG. 3, the system 100 utilizes an analytics modeling approach based on programed models, machine learning (e.g., neural networks, reinforcement learning, etc.), algorithms and other tools to determine RUL and PM schedules. The example shown in FIG. 3 illustrates how as a sensor degrades over time, the failure models update. For example, if a real world failure is detected, the failure circuit 198 recognizes the failure, and the scheduling circuit 202 will schedule a repair in the reactive maintenance schedule. If no failure has occurred, the RUL is determined by the fleet prediction circuit 194, the failure mileage is determined by the failure circuit 198, and the PM schedule is updated to replace the sensor before the predicted threshold failure rate is reached. The RUL and failure mileage will continually update over time based on the real world operating conditions and the information received from the data lake 104 and the vehicle details database 108. Thereby, the system 100 provides a more accurate and continually updated prediction of failures and an improved schedule feature for predictive maintenance.

As shown in FIG. 4, a predicted failure probability curve 250 is generated by the fleet prediction circuit 194. Also shown in FIG. 4 are warranty claims 254 over time that are received from the data lake 104. Service records 258 are received from the vehicle details database 108. In some embodiments, the service records 258 and the warranty claims 254 may be incomplete and the curves are generated within analytics circuit 186. For example, a component warranty may only cover 75,000 miles, and the remainder of the warranty curve is a projection. As discussed above, the determination of the predicted failure probability curve 250 is based on the actual usage of the fleet and the information used to build the warranty records curve 154 and the service records curve 258 and presents and improved prediction when compared with existing options.

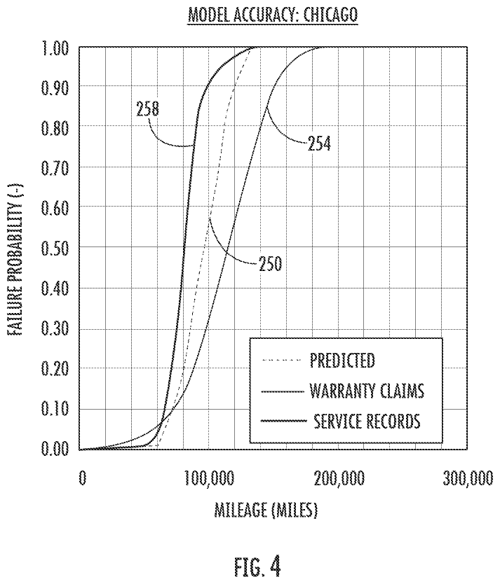

As shown in FIG. 5, the application 144 includes a user interface 262 that includes a fleet description field 266 where the user can enter the target fleet and service life values, a PM interval field 270 where the user can enter a number of different intervals to observe how the selected maintenance interval affects their particular fleet identified in the fleet description field 266, a maintenance and repair cost field 274 that a user can enter costs for repairs and maintenance (these are often different due to the predictable nature of scheduled maintenance as opposed to reactive repairs), a maintenance provider field 278, a repair provider field 282, a failure probability estimate field 286 for selecting the failure model (e.g., a Weibull accelerated failure model), and a chart 290 showing the selected failure probability estimate.

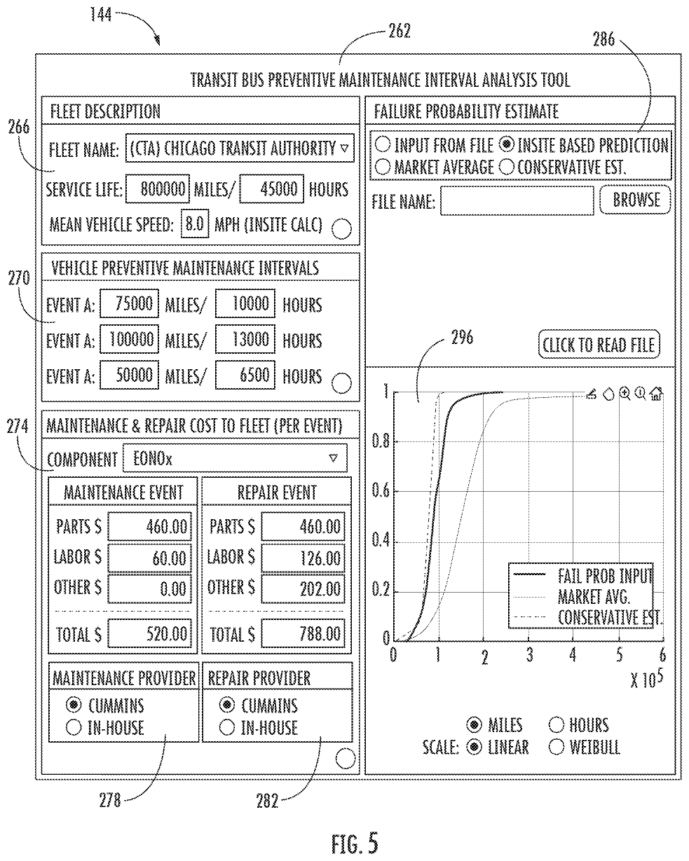

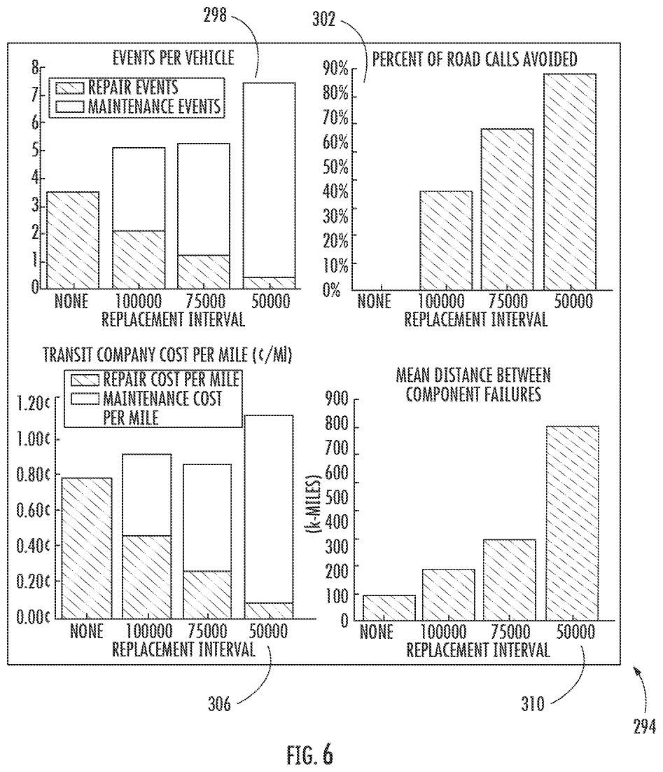

The application 144 is also structured to output a comparison page 294 that compares no predictive maintenance to the intervals selected in the PM interval field 270. As shown in FIG. 6, the comparison page 294 includes an events per vehicle chart comparing the number of combined maintenance and repair events over the selected service life broken down into maintenance events and repair events. As shown, a shorter maintenance interval introduces more maintenance events and reduces the number of reactionary repairs. A percent of road calls avoided chart 302 shows how many road calls are avoided based on the selected maintenance interval. A cost per mile chart 306 shows how the combined cost of repairs and maintenance events results in a total cost for the fleet manager. The cost per mile chart 306 illustrates how the use of the system 100 to select an advantageous PM schedule (e.g., a 75,000 mile schedule) can significantly reduce reactionary repairs and the associated downtime while only increasing the cost by a relatively small margin. This example illustrates how the system 100 provides tangible advantages that are not possible by a human manager of the fleet. A mean distance between failure chart 310 shows how downtime of fleet vehicles can be drastically reduced by using a PM schedule as determined by the system 100.

Regarding algorithm convergence of the prediction engines, algorithms and models discussed above, fleets of small size or that have with no failures or low failure rates have slow convergence when compare to fleets with high failure rates. For example, FIG. 7 shows a slower convergence and a faster convergence. To address the variability of convergence, different percentile predictions are used for best of the best (BOB) and worst of the worst (WOW) fleets. For example, BOB (e.g., fleet failure rate<=20%) with 90th percentile prediction, and WOW (e.g., fleet failure rate>20%) with 75th percentile prediction. Using the convergence modified life prediction results in:

Total Life=Current Miles+((Fleet_H*RUL75)+((1−Fleet_H)*RUL90)),

where Fleet_H represents WOW fleets.

Parameter selection provides that the model with least prediction error is selected. For example, as shown in FIG. 8, a True RUL (shown in blue) is compared to a predicted RUL (shown in yellow). For example, in the chart shown in FIG. 8, the significant parameters for engine out NOx sensors (EONOX) and system out NOx sensors (SONOX) include a percentage duration that the engine ran in a severe coolant temperature condition, the number of months in service, and the fleet failure rate.

Additionally, for the system out NOx sensor, maximum road speed in KMPH and an indicator of low miles per hours (less than 9 mph) were significant parameters driving component remaining life. For a turbo actuator, exemplary duty cycle parameters include key switch cycles, ambient temperature and pressure along with other factors such as those described above.

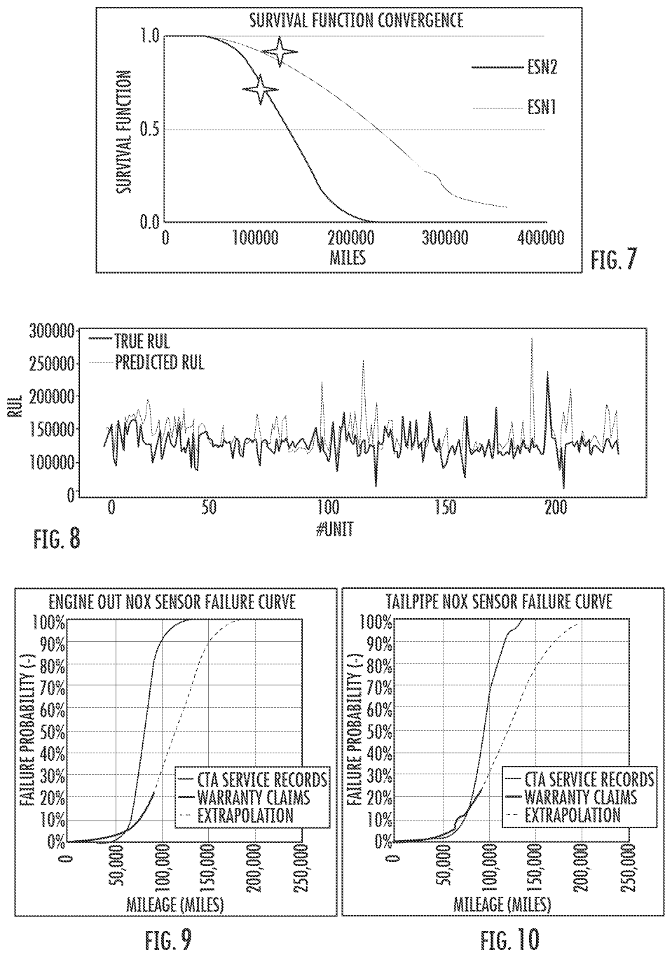

As shown in FIGS. 9 and 10, the target component or sensor may include an engine out NOx sensor and/or a system out (e.g., a tailpipe) NOx sensor and failure and prediction curves can be generated using the system 100 and the details discussed above to determine PM schedules etc. for the engine out NOx sensor and/or the tailpipe NOx sensor. Additionally, the system 100 can be applied to any other sensor or component within the vehicle or vehicle system, as desired.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 2, it should be understood that the controller 156 may include any number of circuits for completing the functions described herein. For example, the activities and functionalities of the data lake circuit 178, the vehicle details circuit 182, the analytics circuit 186, the fleet circuit 190, the fleet prediction circuit 194, the failure circuit 198, the schedule circuit 202, and the reporting circuit 206 may be combined in multiple circuits or as a single circuit. Additional circuits with additional functionality may also be included. Further, the controller 156 may further control other activity beyond the scope of the present disclosure.

As mentioned above and in one configuration, the “circuits” may be implemented in machine-readable medium for execution by various types of processors, such as the processor 164 of FIG. 2. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 100 as shown in the various exemplary embodiments is illustrative only. Additionally, any element disclosed in one embodiment may be incorporated or utilized with any other embodiment disclosed herein.

What is claimed is:

1. An apparatus, comprising:
one or more processing circuits comprising one or more memory devices coupled to one or more processors, the one or more memory devices configured to store instructions thereon that, when executed by the one or more processors, cause the one or more processors to:
receive vehicle information including operating conditions and historical vehicle information,
develop a vehicle model using a machine learning engine that receives the vehicle information,
determine a fleet failure probability based on the vehicle model and fleet information including fleet usage and fleet vehicle types, and
determine a predictive maintenance schedule based on the fleet failure probability.

2. The apparatus of claim 1, wherein determining the fleet failure probability includes determining a remaining useful life of a target component.

3. The apparatus of claim 2, wherein determining the fleet failure probability includes determining a total life prediction based on a current life of the target component and the remaining useful life.

4. The apparatus of claim 3, wherein the one or more memory devices are further configured to store instructions thereon that, when executed by the one or more processors, cause the one or more processors to determine a predicted failure mileage with an associated percentage of likelihood.

5. The apparatus of claim 4, wherein the one or more memory devices are further configured to store instructions thereon that, when executed by the one or more processors, cause the one or more processors to receive a threshold failure rate and query the predicted failure mileage to determine when the failure rate is predicted to be achieved.

6. The apparatus of claim 5, wherein the predictive maintenance schedule provides a recommendation of maintenance for the target component based on a determination that the failure rate is predicted to be achieved.

7. The apparatus of claim 1, wherein the one or more memory devices are further configured to store instructions thereon that, when executed by the one or more processors, cause the one or more processors to generate a report indicating maintenance scheduled within a predetermined period of time in the future.

8. The apparatus of claim 7, wherein the report identifies each component scheduled for maintenance within the period of time.

9. The apparatus of claim 1, wherein the vehicle model receives data lake information including at least one of reliability information, warranty claims, manufacturer information, repair claim history, weather information, fleet vehicle diagnostic information, trip summaries, routing information, or traffic information.

10. The apparatus of claim 1, wherein the vehicle information is specific to at least one of a vehicle, an engine, or an individual component, and includes at least one of: a serial number; a model year; a date put into service; an original equipment manufacturer; a vehicle length; a vehicle usage; a repair history including prior repairs, past fault codes, or replaced parts; ambient history including ambient temperature, ambient pressure, and relative humidity; duty cycle including sample rate or duty cycle, usage rate, engine hours, and odometer readings; or historical diagnostic information.

11. The apparatus of claim 1, further comprising an application communicably coupled to the one or more processing circuits and structured to provide a plurality of predictive maintenance intervals and display a cost per unit of distance associated with each predictive maintenance interval.

12. The apparatus of claim 11, wherein the plurality of predictive maintenance intervals are predefined.

13. The apparatus of claim 11, wherein the one or more memory devices are further configured to store instructions thereon that, when executed by the one or more processors, cause the one or more processors to:
receive the plurality of predictive maintenance intervals from the application, and
generate the cost per unit of distance using the vehicle model.

14. The apparatus of claim 1, further comprising an application communicably coupled to the one or more processing circuits and structured to provide a plurality of predictive maintenance intervals and display an events per vehicle value associated with each predictive maintenance interval.

15. The apparatus of claim 1, further comprising an application communicably coupled to the one or more processing circuits and structured to provide a plurality of predictive maintenance intervals and display at least one of a percentage of on road repairs avoided or a mean distance between component failures associated with each predictive maintenance interval.

16. A system comprising:
one or more processing circuits comprising one or more memory devices coupled to one or more processors, the one or more memory devices configured to store instructions thereon that, when executed by the one or more processors, cause the one or more processors to:
receive vehicle information and fleet information,
develop an analytics model based on the received vehicle information and fleet information,
determine a predicted component life using the analytics model,
determine a predictive maintenance interval based on the predicted component life, and
generate a report indicating maintenance scheduled within the predictive maintenance interval; and
an application communicably coupled to the one or more processing circuits and structured to provide the predictive maintenance interval and display the report.

17. The system of claim 16, wherein determining the predicted component life includes:
determining a remaining useful life of a target component using the analytics model,
determining a total life prediction based on a current life of the target component and the remaining useful life, and
receiving a threshold failure rate from the application and determining when the threshold failure rate is predicted to be achieved based on the remaining useful life.

18. The system of claim 17, wherein the indicated scheduled maintenance in the report is based on a determination that the failure rate is predicted to be achieved.

19. The system of claim 16, wherein the one or more memory devices are further configured to store instructions thereon that, when executed by the one or more processors, cause the one or more processors to:
generate at least one of a cost per unit of distance indicator, an events per vehicle indicator, a road calls avoided indicator, or a mean distance between component failures indicator using the analytics model, and
wherein the report includes the at least one of the cost per unit of distance indicator, the events per vehicle indicator, the road calls avoided indicator, or the mean distance between component failures indicator.

20. A method comprising:
receiving vehicle information and fleet information;
developing an analytics model based on the received vehicle information and fleet information;
determining a total life prediction using the analytics model and based on a current life of a target component and a remaining useful life of the target component;
receiving a threshold failure rate;
determining when the threshold failure rate is predicted to be achieved based on the total life prediction;
determining a predictive maintenance interval based on the total life prediction;
generating a report indicating maintenance scheduled within the predictive maintenance interval and indicating when the threshold failure rate is predicted to be achieved based on the total life prediction; and
displaying the report.
